(19) United States
(12) Patent Application Publication
(10) Pub. No.: US 2026/0320405 A1
(43) Pub. Date: Oct. 15, 2026

(54) AI-DRIVEN COURSE OF ACTION GENERATION USING NEURO-SYMBOLIC METHODS

(71) Applicant: Charles River Analytics, Inc., Cambridge, MA (US)

(72) Inventors: Michael Harradon, Arlington, MA (US); Jeff Druce, Anaconda, MT (US); Kevin Golan, Cambridge, MA (US); Brad Rosenberg, Arlington, MA (US); Rob Hyland, Bedford, MA (US)

(73) Assignee: Charles River Analytics, Inc., Cambridge, MA (US)

(21) Appl. No.: 19/644,306

(22) Filed: Apr. 10, 2026

Related U.S. Application Data
(60) Provisional application No. 63/786,561, filed on Apr. 10, 2025.

(51) Int. Cl. G06N 3/092; G06N 3/044

(52) U.S. Cl. CPC G06N 3/092; G06N 3/044

(57) ABSTRACT

A computer-implemented system and method for training and deploying deep reinforcement learning (DRL) agents using neural program policies (NPPs) is disclosed. An NPP comprises a policy program authored in a domain-specific language (DSL) embedded in a general-purpose programming language, wherein the DSL defines procedural OBSERVE, ACT, REWARD, and DONE instructions that transform an open-structured partially observable Markov decision process (POMDP) into a structured, learnable DRL representation. An adaptive multiheaded recurrent neural network architecture reactively instantiates deep neural network (DNN) head models matched to dynamically encountered action space specifications and observation types, sharing a common fixed-size recurrent core. An autoregressive predictive model trained jointly with the policy serves as a surrogate model of the environment, enabling training at computational speeds orders of magnitude faster than direct environment simulation. The resulting system generates interpretable courses of action (COA) traces rendered in a human-machine interface supporting human-AI collaborative planning.

### CROSS-REFERENCE TO RELATED APPLICATIONS

This application claims priority to U.S. Provisional Patent Application No. 63/786,561, filed Apr. 10, 2025, the entire content of which is hereby incorporated by reference.

### STATEMENT REGARDING FEDERALLY SPONSORED RESEARCH OR DEVELOPMENT

The present disclosure was made with government support under Contract No. HR0011-24-C-0421 with the Defense Advanced Research Projects Agency. The government has certain rights in the invention.

### BACKGROUND

Artificial intelligence (AI)-based systems show great promise for supporting complex decision-making and planning. AI systems can consider a massive option space that far exceeds current human processes. Notably, AI systems, particularly deep reinforcement learning (DRL), achieved expert levels of play for strategy games, generating innovative strategies by exploring numerous courses of action (COAs) to make successful strategic choices in complex scenarios. The opportunity exists for AI systems to assist human planning staffs with constructing more high-quality plans, analyzing plan strengths and weaknesses more deeply, and exploring a larger number of plan alternatives in a fixed planning time. AI-based modeling and simulation could accelerate COA planning activities that require reasoning across multiple, interconnected domains. Such planning support considers interacting effects across physical domains (e.g., air, land, sea, undersea) and interacting support functions (e.g., logistics, communications)—a massive action space to consider—which exceeds the action space processed by state-of-the-art game-playing systems.

Despite these advances, a distinct class of technical difficulties emerges when the decision interface itself becomes large, structured, or dynamically varying over time. When control must be allocated across many entities or degrees of freedom, the joint action space can expand combinatorially. Conventional DRL agents instantiated against fixed observation encoders and action interfaces are ill-suited to partially observable settings where admissible actions or observation fields change with state and time—problems the present disclosure refers to as open-structured partially observable Markov decision processes (POMDPs). Further difficulties arise from long planning horizons, partial observability, and the inherent opacity of high-performing neural policies, which are often difficult to inspect or communicate to domain specialists.

### SUMMARY

The present disclosure relates to computer-implemented systems for training and deploying deep reinforcement learning agents. More particularly, the disclosure concerns hybrid neural and symbolic policy architectures that combine programmatic policy representations—including policies expressed in a domain-specific language—with adaptive recurrent neural network components for decision-making in partially observable environments having large, structured, or dynamically varying action interfaces.

In one aspect, a computer-implemented method for training a deep reinforcement learning (DRL) agent may include executing, by one or more processors, a policy program (PP) written in a domain-specific language (DSL) to generate a sequence of agent-environment interactions. The DSL may include callable procedural instructions for receiving environmental observations, selecting actions from dynamically specified action spaces, providing reward signals, and signaling episode termination. Action space specifications and observation dimensionalities encountered during execution may vary dynamically within an episode. The one or more processors may reactively instantiate, by a plurality of deep neural network (DNN) head models during PP execution, each DNN head model having an architecture matched to a distinct action space specification or observation dimensionality encountered during execution. The one or more processors, may train the plurality of DNN head models jointly with a shared fixed-size recurrent core neural network on a plurality of episodes. The shared recurrent core may autoregressively condition on all prior observations and actions within an episode to generate predictive distributions over future observations and rewards. The one or more processors may train subsequent episodes against a surrogate model derived from the trained predictive distributions in lieu of direct environment simulation.

The method may include, alone or in combination, one or more of the following features. The callable procedural instructions may comprise an OBSERVE instruction that receives a numerical array representing environmental state information, an ACT instruction that receives an action space specification and returns an action selection, a REWARD instruction that provides a scalar reward signal, and a DONE instruction that signals episode termination. The shared fixed-size recurrent core may comprise a dual hidden state including a spatial hidden state encoding spatially structured observations and a vector hidden state encoding non-spatial state information. The predictive distributions over future observations may take the form of diagonal Gaussian distributions having means and variances parameterized by outputs of respective DNN head models receiving the recurrent hidden state as input.

Training may comprise applying an actor-critic objective in which a critic network estimates long-term value of agent states and an actor network parameterizes a policy over action selections. The callable procedural instruction for selecting actions may accept a log-prior distribution over the action space, and wherein the DNN policy combines the log-prior with a learned log-probability distribution to produce a constrained action selection. The PP may encode at least one domain-specific subpolicy as a callable subroutine that, upon invocation, issues a predetermined sequence of environment actions spanning a plurality of environment time steps. The domain-specific subpolicy may be a pulse-width modulation subpolicy that selects an on-action, an off-action constrained to differ from the on-action, an on-time duration, an off-time duration, and a number of periods, each selected from a respective set of discrete values, and repeatedly applies the on-action for the on-time duration and the off-action for the off-time duration for the selected number of periods. The autoregressive predictive distributions may be updated by minimizing a cross-entropy loss between predicted and actual observations received from the environment. Episode duration, measured as the total number of observation-receiving and action-selecting calls per episode, may decrease over training as the agent learns to achieve target rewards with fewer intermediate steps.

Action space complexity may be measured by an empirical log action tree width equal to the sum of the log of the number of choices in each action space encountered during PP execution. The trained agent may achieve a reduction in empirical log action tree width of at least ten times relative to the primitive action space. A plurality of instances of the environment may be executed in parallel during training and aggregating experience from the plurality of parallel instances to update the shared fixed-size recurrent core neural network and the plurality of DNN head models. The DSL may be embedded in the Python programming language and the PP is authored as a Python program that invokes the callable procedural instructions as Python function calls. The PP may further invoke at least one external machine learning model as a callable library within the PP, wherein the external model provides auxiliary predictions or classifications used to condition action selections.

According to another aspect, a system for training and executing a deep reinforcement learning (DRL) agent may include one or more processors and one or more non-transitory computer-readable storage media storing instructions that, when executed by the one or more processors, cause the system to implement a policy program module configured to execute a domain-specific language comprising callable procedural instructions for receiving environmental observations, selecting actions from dynamically specified action spaces, providing reward signals, and signaling episode termination, wherein action space specifications and observation dimensionalities vary dynamically within an episode. A dynamic head instantiation module may be configured to reactively construct a plurality of DNN head models during policy program execution, each having an architecture matched to a distinct action space specification or observation dimensionality encountered during execution. A recurrent core module may comprise a fixed-size recurrent neural network shared across the plurality of DNN head models and may be configured to maintain a hidden state encoding long-range dependencies across heterogeneous observations and actions. A surrogate model module may be configured to train autoregressive predictive distributions over future observations and rewards jointly with the plurality of DNN head models and the recurrent core module, and to execute training episodes against the trained predictive distributions in lieu of direct environment simulation. An execution trace module may be configured to record a hierarchical log of observations, action selections, reward values, and annotated policy program subroutine data, and to render the hierarchical log in a human-machine interface for human inspection and analysis.

The system may include, alone or in combination, one or more of the following features. The dynamic head instantiation module may reuse a previously constructed DNN head model when a subsequently encountered action space specification or observation dimensionality matches a previously encountered one. The recurrent core module may generate predictive distributions over step-by-step rewards in addition to predictive distributions over observations, and wherein both are used to generate surrogate model training data. The surrogate model module may execute training episodes at a per-episode runtime that decreases over the course of training as the agent learns shorter execution paths. The execution trace module may record, for each annotated policy program subroutine, a subroutine identifier, a timestamp relative to episode start, input argument values, and return values, and associates each recorded entry with a corresponding geographic location and simulated time in the human-machine interface. The surrogate model module may execute training episodes at a computational speedup of at least 100 times relative to direct environment simulation.

In another aspect, a non-transitory computer-readable medium storing one or more instructions that, when executed by at least one processor, may cause the at least one processor to execute a policy program written in a domain-specific language comprising callable procedural instructions for receiving environmental observations, selecting actions from dynamically specified action spaces, providing reward signals, and signaling episode termination. Action space specifications and observation dimensionalities may vary dynamically within an episode. A plurality of DNN head models may reactively instantiate during policy program execution, each having an architecture matched to a distinct action space specification or observation dimensionality encountered during execution. The plurality of DNN head models may train jointly with a shared fixed-size recurrent core neural network on a plurality of episodes. The shared recurrent core may autoregressively condition on all prior observations and actions within an episode to generate predictive distributions over future observations and rewards. Subsequent episodes may train against a surrogate model derived from the trained predictive distributions in lieu of direct environment simulation. A plurality of action traces may be output, each comprising a time-ordered sequence of agent-selected actions and corresponding environmental observations recorded during a simulated episode.

The computer-readable medium may further include, alone or in combination, one or more of the following features. The one or more instructions may further cause the at least one processor to cluster the plurality of action traces into strategy clusters based on structural similarity of action sequences, and select at least one representative action trace from each cluster for presentation to a human operator. Each action trace may be annotated with a hierarchical execution log generated by a trace decorator applied to policy program subroutines, the log recording subroutine identifiers, input argument values, and return values at each subroutine invocation.

In another aspect, a computer-implemented method for generating courses of action (COAs) for a multi-domain planning system may include receiving, by one or more processors, a trained neural program policy comprising a policy program encoding domain-specific subroutines for issuing commands to assets across at least two physical domains selected from air, land, sea, and undersea domains, and a trained autoregressive recurrent neural network comprising a plurality of DNN head models and a shared fixed-size recurrent core. The one or more processors may execute the trained neural program policy against a surrogate model of a multi-domain environment to generate a plurality of COA traces, each comprising a time-ordered sequence of agent-selected actions and corresponding environmental observations, at a computational rate at least 1,000 times faster than direct execution against the environment. The one or more processors may cluster the plurality of COA traces into strategy clusters based on structural similarity of action sequences. The one or more processors may render at least one representative COA trace from each strategy cluster in a human-machine interface comprising a geographic map view displaying unit movements and engagements over simulated time and a hierarchical timeline view displaying policy program subroutine execution with associated argument and return values.

The method may further include, alone or in combination, one or more of the following features. The physical domains may further include at least one of sensor networks, communication networks, and logistics and resource management systems. The surrogate model may execute at a computational rate at least 10,000 times faster than a real-time equivalent engagement duration of the multi-domain environment. The human-machine interface may further comprise a policy program view displaying policy program source code alongside the geographic map view, wherein selecting an event in the hierarchical timeline view causes the interface to display argument and return values associated with the selected event. The plurality of COA traces may comprises at least 1,000 COA traces generated within 24 hours on a computing system comprising a single graphics processing unit.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Furthermore, embodiments are illustrated by way of example and not limitation in the figures, in which:

FIG. 1A is a flow diagram of a neural program policy (NPP) implementation, according to aspects of the present disclosure;

FIG. 1B is a diagram of an example NPP, according to aspects of the present disclosure;

FIG. 2 is an example code segment for a pulse-width modulation NPP, according to aspects of the present disclosure;

FIG. 3 is a diagram of example deep reinforcement learning (DRL) control tests, according to aspects of the present disclosure;

FIG. 4 is a series of plots showing the results of a pulse-width-modulation NPP, according to aspects of the present disclosure;

FIGS. 5A-5B are plots showing resulting decrease in action space and episode duration, according to aspects of the present disclosure;

FIG. 6 is a plot of cross-entropy between true simulation observables and predicted distribution of observables, according to aspects of the present disclosure;

FIG. 7 is a depiction of a surrogate model runtime over the course of a training period, according to aspects of the present disclosure;

FIG. 8 is a plot showing Mean Episode Observation Count, according to aspects of the present disclosure;

FIG. 9 is a plot showing Empirical Mean Log Action Tree Width, according to aspects of the present disclosure;

FIG. 10 depicts a visualization of NPP execution, according to aspects of the present disclosure;

FIG. 11 is a flow diagram of an example method for training a DRL agent using an NPP, according to aspects of the present disclosure; and

FIG. 12 is a flow diagram of an example method for generating courses of action for a multi-domain planning system, according to aspects of the present disclosure; and

FIG. 13 is a diagram of an example of a computing device, according to aspects of the disclosure.

### DETAILED DESCRIPTION

Artificial intelligence (AI) has achieved success across a wide range of applications, including vision, language generation, decision-making, autonomy, and robotics. Aspects of the present disclosure provide concepts, techniques, and structures using AI in decision-support, specifically using deep reinforcement learning (DRL), where effective modeling and simulation techniques are critical enablers. In DRL, an agent is tasked with finding the optimal sequence of actions that will lead to maximized rewards given some environment. DRL has drawn significant attention following demonstrations of expert-level performance in complex strategic games, and DRL systems have since been applied to increasingly challenging decision-making problems, often producing creative, unexpected strategies. Such successes have led researchers and practitioners to pursue the potential of DRL in broader decision-making contexts, enabling DRL to integrate with and expand learning and simulation techniques.

With these advances, DRL may also be particularly well suited as an assistive system for decision-making because it may analyze the strengths and weaknesses of a wide set of decision pathways at each model training iteration. Aspects of the disclosure, as described herein, may provide a DRL-based AI system to support planning staffs, such as those who plan complex operations and logistics, dealing with task allocation problems in long-duration, real-world, multi-domain scenarios.

Aspects of the present disclosure utilize DRL-based AI agents to enable a human-AI team paradigm for decision-making, specifically for generating innovative plan strategies by exploring numerous courses of action (COAs) to increase the number and quality of multi-domain plans considered for complex scenarios. According to one aspect, a COA may be defined as a time-phased or situation-dependent plan that features effective strategies to achieve human-specified and multi-domain objectives with dynamic uncertainty. AI agents may be considered to generate COAs if they output multiple action traces—that is, execution paths recorded during simulation runs with respect to agent-chosen actions—that achieve the human-specified objectives through sequenced strategies and tactics. As used herein, such AI-agent outputs may be referred to as COA traces.

Aspects of the present disclosure detail how COA traces may assist human planning staffs in constructing more high-quality plans, analyzing plan strengths and weaknesses more deeply, and exploring a larger number of plan alternatives in a fixed planning time. Such DRL-based modeling and simulation may accelerate COA planning activities, and the generation of novel plan strategies may be useful for training staff to develop more robust plans.

Constructing agents with planning capabilities is a long-standing challenge for AI, and it is especially challenging for agents to generate complex multi-domain COAs. Traditional DRL techniques can be difficult to apply in environments or games with complex structures where widely different decisions need to be made. When developing a DRL model, a key challenge is to define the set of actions that may be relevant for the agent's problem and the reward functions that will steer the model toward learning an optimal policy.

This challenge is further complicated in environments described by partially observable Markov decision processes (POMDPs), where agents are often tasked to choose among actions that may be completely orthogonal to each other. For instance, in a real-time strategy environment used as a productive AI agent testbed, an agent may be required to optimally construct a COA trace that simultaneously accomplishes multiple objectives: gathering and managing resources, constructing multi-domain forces, executing maneuvers, scouting, and executing attack and defense plans. These, in turn, may involve several subroutines that need to be well executed under dynamic uncertainty. When there is multimodality in the tasks that need to be solved by the agent, it may make little sense to learn an all-encompassing policy that considers all possible actions for every observation. Some observations may be more informative for action selection than others, and that may vary by time and context. As described herein, such problems where action spaces and observation structures vary over time may be referred to as “open-structured POMDPs.” One approach to address this class of problems may be to construct different neural networks tailored for different tasks—for example, one for maneuvers and one for effective attack plans. However, doing so may be challenging because it may require both subject matter expertise and deep learning expertise to carefully define the relevant policies and rewards and translate these policies into architectures that can be jointly learned within the environment.

Aspects of the present disclosure introduce neural program policies (NPPs), a neuro-symbolic hybrid-AI architecture designed to address the challenges described above. NPPs may provide a framework that abstracts away the orchestration and design of deep learning architectures tailored to learn and act in a dynamic environment with multidimensional uncertainty and, instead, may allow AI developers to focus on targeted policy design and representation via an expressive domain-specific language (DSL). The DSL may be used to wrap the reinforcement learning problem into a more explainable representation that is easier to solve, understand, and analyze—enabling greater end-user transparency than black-box end-to-end deep learning systems. As part of the NPP framework, AI developers and/or subject matter experts (SMEs) may encode prior domain knowledge using symbolic AI representations in a policy program (PP) DSL to express knowledge or insights about the problem domain—for example, by restructuring the action space of the agent into a smaller or more easily learned set. This NPP neuro-symbolic framework may enable more data-efficient learning.

As used herein, the following terms have the meanings set forth below. A policy program (PP) is a program authored in the NPP DSL that defines the structure of agent-environment interaction, including the sequence and type of OBSERVE, ACT, REWARD, and DONE calls. An episode is a sequence of interactions between an agent and its environment, beginning from an initial state and terminating at a terminal state upon receipt of a DONE signal. A DNN head model is a neural network module having an architecture matched to a specific action space specification or observation type, instantiated reactively during PP execution. A surrogate model is an autoregressive predictive model of the environment, formed from trained predictive distributions over future observations and rewards, and used as a replacement for direct environment simulation during training. A COA trace is a time-ordered sequence of agent-selected actions and corresponding environmental observations recorded during a simulated episode, constituting a candidate course of action.

In the following disclosure, NPP technical details are described. An exemplary embodiment is provided to lay the groundwork for what a complex, multi-domain DRL problem may look like and what DRL challenges may emerge when interacting with more complex environments. The exemplary embodiment also illustrates ways an NPP application may materially assist a human planning team. The technical details underlying NPPs are then described, providing intuition about the DSL's policy representation and an introduction to how programs written in this DSL may encapsulate open-structured POMDPs. The NPP architecture is then described, which may feature an autoregressive core with a multiheaded structure for its observation and policy models. Experimental results are provided on two problem categories: (1) demonstrating effectiveness for benchmark control tasks, and (2) generating COA traces using an extended, multi-domain simulation environment. Results address NPP performance including the generation of multi-domain COA traces, surrogate model speedup relative to direct environment simulation, action space reduction, and the interpretation of AI-generated COA traces by human planning staffs.

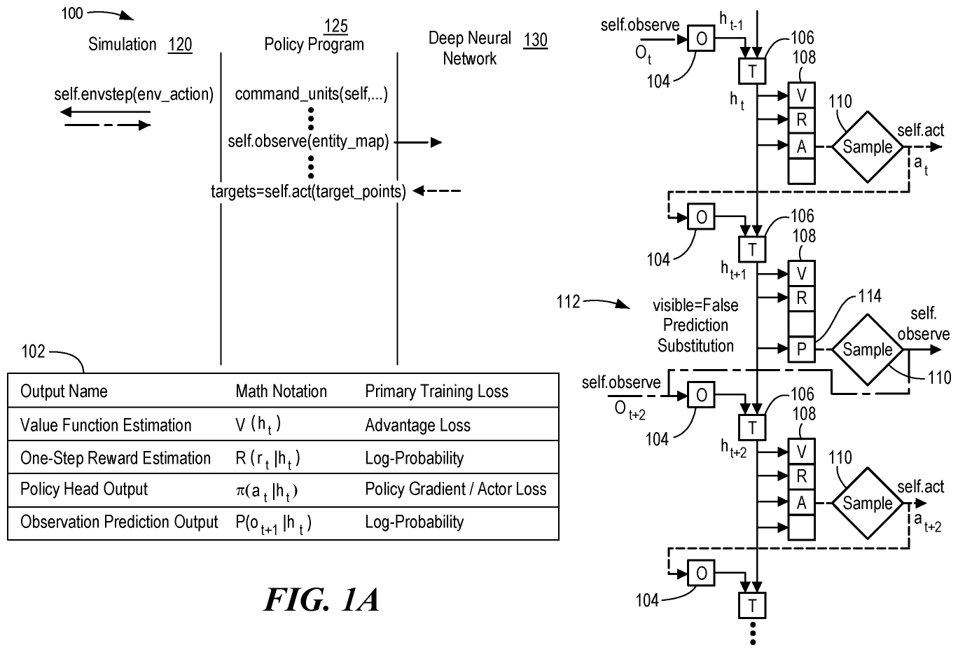

Turning now to FIG. 1A, an NPP framework 100 is depicted, illustrating the interaction among three components: a simulation 120, a policy program 125, and a deep neural network (DNN) 130.

According to one aspect, the simulation 120 may interface with the policy program 125 through environment step calls (e.g., self.envstep(env_action)), which may return observations to the policy program 125 and accept actions from it. The policy program 125 may comprise a set of callable subroutines (e.g., command_units(self, . . . )) that invoke OBSERVE and ACT instructions to exchange information with the DNN 130. For example, self.observe(entity_map) may constitute an OBSERVE call that passes an observation array to the DNN 130, and targets=self.act(target_points) may constitute an ACT call that requests an action selection from the DNN 130 and returns the selected action to the policy program 125 for execution in the simulation 120.

The DNN 130 may comprise an unrolled recurrent architecture that processes a sequence of OBSERVE and ACT calls over an episode. For each OBSERVE call at time step t, an observation oₜ may be passed to an observation head model 104 (labeled “O” in FIG. 1A). The output of the observation head model 104 may update a recurrent hidden state hₜ via a recurrent core module 106 (labeled “T” in FIG. 1A). The recurrent core module 106 may maintain a hidden state encoding long-range dependencies across all prior observations and actions in the episode.

According to one aspect, at each time step, the recurrent hidden state hₜ may be processed by multi-head DNN outputs 108 (labeled “V,” “R,” and “A” in FIG. 1A) to produce the following outputs, as shown in the output table 102 of FIG. 1A: a value function estimate V(hₜ), trained using an advantage loss; a one-step reward estimate R(rₜ|hₜ), trained using a log-probability loss; and a policy head output π(aₜ|hₜ), trained using a policy gradient or actor loss. For each ACT call, the policy head output π(aₜ|hₜ) may be sampled via an action sampler 110 (shown as a diamond in FIG. 1A) to produce an action selection aₜ, which may be returned to the policy program 125.

The DNN 130 may also comprise a prediction head 114 (labeled “P” in FIG. 1A) that may generate an observation prediction output P(Oₜ₊₁|hₜ), trained using a log-probability loss. The prediction head 114 may form the basis of a surrogate model of the simulation 120. During surrogate model execution, a prediction substitution region 112 (shown as a dashed region labeled “visible=False/Prediction Substitution” in FIG. 1A) may replace actual simulation observations with observations sampled from the trained predictive distribution P (oₜ₊₁|hₜ). This mechanism may enable the NPP framework 100 to generate training episodes without requiring direct interaction with the simulation 120. Because surrogate model steps may be defined at the level of PP-abstracted OBSERVE and ACT calls rather than at the native simulation stepping rate, the surrogate model may execute orders of magnitude faster than direct simulation.

According to one or more aspects, the DSL may define typical DRL elements as callable procedures rather than as results that are simply passed back and forth, thereby extending typical definitions of objectives/reward signals, observations, and actions. Action statements may be passed as a specification of a set, or a prior distribution over a set of actions. The NPP framework 100 may enable request of an action or provision of an observation at any time during episode execution. The DSL may connect human-expressible symbolic representations of observations, actions, and target objectives/reward signals, together with DNN head models (e.g., any DNN approach such as CNNs, ANNs, transformers, or other architectures), to specific environments (e.g., large datasets, simulators, sensors, and actuators).

According to one aspect, a universal generative, autoregressive neural network (e.g., an RNN or transformer) may be trained on multiple instances of agents running policy programs 125 in instances of the simulation 120, or on datasets. This training may include connected machine learning heads and environmental interfaces. Dynamic orchestration of the different head models to particular steps of policy program 125 execution may be provided. The neural network architecture may adapt to the execution sequence and may accept different sequences, learning appropriate behaviors across different sequences toward the specified objectives and reward signals.

According to one aspect, the NPP framework 100 may optionally learn to predict observations before they occur, in order to improve the features learned with a reduced number of environment interactions. The predictive model may also be used as a replacement for the simulation 120 (i.e., as an internal world model or surrogate model), driving down the cost of learning agent behaviors. As episodes unfold, estimated and actual rewards in the autoregressive neural network may drive the model weightings toward behaviors for desirable outcomes, which may be incorporated into future training runs. Aspects of the disclosure may further include DRL value estimation approaches (e.g., an Actor-Critic model) to optimize actions for long-term reward.

According to one aspect, after training, the policy program 125 and the trained autoregressive model may be integrated into any number of autonomous systems to drive agent behavior by executing learned behaviors. The NPP framework 100 may remain inspectable during execution based on NPP observations, actions, and policy program 125 execution.

According to one aspect, as described herein, the disclosed concepts, techniques, and structures may generally include: (a) a DSL implementation that may allow AI developers to describe structured policy programs 125 and generalized COA templates incorporating SME knowledge, to express fundamental domain concepts and decompose the decision problem into learnable constructs; (b) an adaptive DNN architecture 130 that may use DSL-encoded knowledge to generate COA traces by fitting the functional approximations required to describe policies, predictions, and other outputs for the DSL-defined open-structured POMDP; and (c) experiments on two problem categories, namely benchmark control tasks and COA trace generation using a multi-domain simulation environment extended with additional physical domains and support functions.

The following exemplary embodiment illustrates the NPP framework 100 in the context of a complex, multi-domain planning problem.

### Exemplary Embodiment

According to one aspect, the following exemplary embodiment is described to illustrate the NPP framework 100. Other implementations and applications are possible without departing from the scope of the present disclosure.

According to one aspect, a simulation-based multi-domain planning environment may be used as the foundation of the present exemplary embodiment because such environments may provide useful AI benchmarks. AI algorithms have demonstrated performance in board games and retro video game environments, and related approaches have reached high levels of performance in complex real-time strategy games. However, such approaches may have shortcomings in their COA trace generation capability and performance. For example, they may require a large number of environmental steps to train on new problems, which may be too slow to assist many human planning processes, and they may not express plans or strategies in human-understandable representations. To illustrate the approach described herein, a real-time strategy game environment is used and extended. AI agents may be required to learn and present COA traces to assist human planning staffs in constructing more high-quality plans, analyzing plan strengths and weaknesses more deeply, and exploring a larger number of plan alternatives in the same amount of planning time as allotted to human staffs.

There are several key elements to the exemplary embodiment, including a challenge scenario that may require novel solutions. A complex challenge scenario may be implemented by human SMEs—multi-domain scenario design experts—involving thousands of multi-domain units consisting of various types of air, land, sea, and undersea assets. The scenario may purposely disadvantage one side (e.g., Team 1), so that human or AI planners may require novel strategies and tactics to defeat the stronger adversary (e.g., Team 2). For example, Team 1 may need to conduct a multi-staged application of novel strategies and resource management to defeat Team 2. In one aspect, the AI agent may play Team 1 to exploit weaknesses and defeat a Team 2 COA, so that planners may improve the Team 2 COA under consideration.

According to one aspect, a multi-domain environment may be provided. To better reflect real-world uncertainty and interconnections among multiple domains, a simulation environment may be employed that is extended with specialized, higher-fidelity models to add sea and undersea physical domains, as well as models for sensors, communications, and resource management. The AI agent may learn environmental rules and effective strategies from multiple adjudicating models that may add multidimensional uncertainty beyond the base simulation environment's built-in uncertainty mechanisms.

According to one aspect, generation of COAs may be faster than human planners. To better reflect real-world, time-phased COAs that are robust to adversary and environmental uncertainty, the scenario may span longer periods of time compared to traditional simulation engagements. The AI agent may generate high-quality plans that are robust to adversary options and produce many alternatives. The goal may be to generate more high-quality COA traces than a human staff could generate in the same amount of time. To achieve this, the AI agent may feature high sample efficiency, for example by achieving useful training times with a manageable number of environment observations.

Human-understandable insights may provide another key element. The AI agent may both demonstrate COA traces that achieve the planning objectives and convey the strategies used (and why they worked) to assist a human planning process. This may require plan visualization techniques that allow human planning staff to understand plan alternatives and select one or more COA traces, and, perhaps more importantly, to explore strengths and weaknesses of the adversary's plan options and gain insights for reducing the adversary's advantage. Based on the AI-generated output, the human staff may select a COA trace that exhibits useful insights and possesses a multi-phased plan that reliably leads to achieving the planning objective.

According to one or more aspects, NPPs may be used to implement the key elements described above. To achieve the COA generation goals, AI agents may address corresponding technical challenges, including: (1) learning a substantially reduced action space to lower training time; (2) incorporating domain-specific knowledge into machine learning (ML) methods to scale to large scenarios; (3) explaining what is learned to support human planning processes; and (4) reasoning over open-structured POMDPs to manage uncertainty and interconnections among multiple domains.

### Policy Program and Domain-Specific Language

NPPs may offer tools that allow AI developers to define action sets and subpolicies that are targeted and effective for domain-specific tasks. This may be accomplished primarily by authoring a policy program 125. As used herein, policy programs 125 may be specified in a DSL that allows the developer to write programs that: (1) interface with the simulation 120 in which the agent operates; (2) transform the open-structured POMDP into a more explainable, tractable DRL representation; and (3) incorporate domain expertise into the way the agent should act within the modified representation. The DSL may be used to write programs that describe a policy skeleton that the agent may follow for various developer-defined domains. The NPP framework 100 may integrate this policy program 125 DSL into a DRL architecture.

According to one aspect, a PP DSL may include four instructions that allow developers to construct a policy program 125 and transform the DRL problem: OBSERVE, ACT, REWARD, and DONE. OBSERVE may be a function called with arguments representing information that the agent may use to update its internal recurrent state, for the purpose of affecting future actions or other predictions. In one implementation, OBSERVE may be passed an array of numbers, though the shapes of those arrays may vary freely during execution. ACT may be a function that takes a specification of an action space and returns a selection from that space as determined by the DNN 130 policy. In one implementation, finite discrete action spaces may be a focus. REWARD and DONE may have the standard DRL interpretations, specifying a reward to provide to the agent or signaling the completion of an episode, respectively.

According to one aspect, an episode may be the sequence of interactions between an agent and its simulation 120, starting from an initial state and ending at a terminal state. One implementation may embed the DSL in the Python programming language, though it may be embedded in any general-purpose programming language, as only forward execution semantics may be required to train or run NPP agents.

With a policy program 125 designed to support these instructions, developers may focus agent learning on salient factors in the domain via targeted actions, observations, and rewards based on expertise or insight. For instance, one may enforce that agents employ certain behaviors that would otherwise need to be learned over many episodes. For example, subroutines may be written so that the agent pursues a first strategy when encountering a first class of environmental conditions and a second strategy when encountering a second class of environmental conditions. Furthermore, policy programs 125 may employ the full expressivity of the host programming language, including stateful computation, library calls, and interfaces with other ML or AI systems.

### NPP and Adaptive Multiheaded Recurrent Architecture

Referring now to FIG. 1B, an NPP example is shown using a policy program 125 (left) alongside the multi-headed recurrent DNN architecture 130 (right). The policy program 125 may include a main loop and three callable subroutines: wait( ), select( ), and move( ). ACT calls are indicated in FIG. 1B by NPP.discrete( ) function calls, OBSERVE calls by NPP.observe( ) function calls, and REWARD calls by NPP.reward( ) function calls.

One consequence of employing policy programs 125 is that the resulting POMDPs may be open-structured. Because varying action spaces and observation dimensions may be encountered during execution (e.g., observations for resource gathering may have different dimensions than observations for unit movement), the DNN architecture 130 may be constructed to handle heterogeneous representations. The expressiveness of the PP DSL may further require that the architecture 130 handle new structures on the fly, as future action and observation representations cannot be known precisely in advance without executing the policy program 125, which may include coupled execution with the simulation 120.

To address this, the NPP framework may reactively instantiate action head models 108 (labeled “A” in FIG. 1B) and observation head models 106 (labeled “O” in FIG. 1B) for each distinct action space specification or observation type encountered during policy program 125 execution. As shown in FIG. 1B, a first action head model A₀ (108) may be instantiated for the first ACT call encountered in the main loop, and a first observation head model O₀ (106) may be instantiated for the first OBSERVE call encountered in the wait( ) subroutine. Subsequently, within the select( ) and move( ) subroutines, a second action head model A₁ (108) and a second observation head model O₁ (106) may be instantiated for the distinct action space specifications and observation types encountered therein. Where a subsequently encountered specification or type matches a previously encountered one, the previously instantiated head model may be reused rather than a new model being instantiated. All instantiated head models 106, 108 may share the common fixed-size recurrent core modules 104 (labeled “T” in FIG. 1B), which may maintain a hidden state encoding long-range dependencies across all past observations and actions. In one implementation, the recurrent core module 104 may comprise a variant of a recurrent neural network with dual spatial and vector hidden state representations, wherein the spatial hidden state may encode spatially structured observations and the vector hidden state may encode non-spatial state information.

In addition to learning policy and value outputs at each time step, the NPP framework may learn predictive distributions for each observation that arrives. Via the recurrent core modules 104, these predictions may be made autoregressively by conditioning on all past observations and actions. A predictive model may be similarly learned for step-by-step rewards. Both models may take the form of diagonal Gaussian distributions with means and variances parameterized by the outputs of DNN head models 106, 108 receiving the recurrent hidden state as input. These predictive models may form the basis for a surrogate model of the simulation 120, providing a source of training data for the NPP framework in lieu of actual simulation samples. Furthermore, because predictions may be made only when OBSERVE or ACT calls occur in the policy program 125, the surrogate model steps may be defined as PP-level abstractions rather than at the native simulation stepping rate. In later results, measures of this sort may be referred to as “episode duration.” These factors may drive substantial speedup of the surrogate model, in practice reaching relative speedups of 1,000 times or more over the reference simulation.

### Training the NPP

Training of the NPP framework, such as NPP framework 100, may proceed as follows.

First, one or more instances of the policy program may be executed against the simulation to generate episodes. After initial training, episodes may be generated against the surrogate model in lieu of the simulation. Multiple instances may be executed in parallel to accelerate data collection. In one implementation, twenty-four instances may be executed in parallel.

During each episode, DNN head models 106, 108 may be reactively instantiated for each distinct action space specification and observation type encountered, as described above. Where a subsequently encountered specification or type matches a previously instantiated head model, that head model may be reused rather than a new model being instantiated.

The shared recurrent core module 104 may be updated based on the sequence of observations and actions encountered during the episode, autoregressively conditioning on all prior observations and actions within the episode.

An actor-critic training objective may be applied, wherein a critic network may estimate the long-term value of agent states and an actor network may parameterize a policy over action selections returned by the ACT instruction.

The observation and reward predictive models may be updated to minimize the cross-entropy loss between predicted distributions and actual observations and rewards received during the episode. Formally, for observation of at time step t, the predictive distribution may take the form:

p(oₜ|o₁:ₜ₋₁,a₁:ₜ₋₁)=N(μₜ,diag(σₜ²))

where μₜ and σₜ² may be parameterized by the output of the corresponding observation head model 106 applied to the recurrent hidden state hₜ of the recurrent core module 104. A predictive model for step-by-step rewards may be similarly learned.

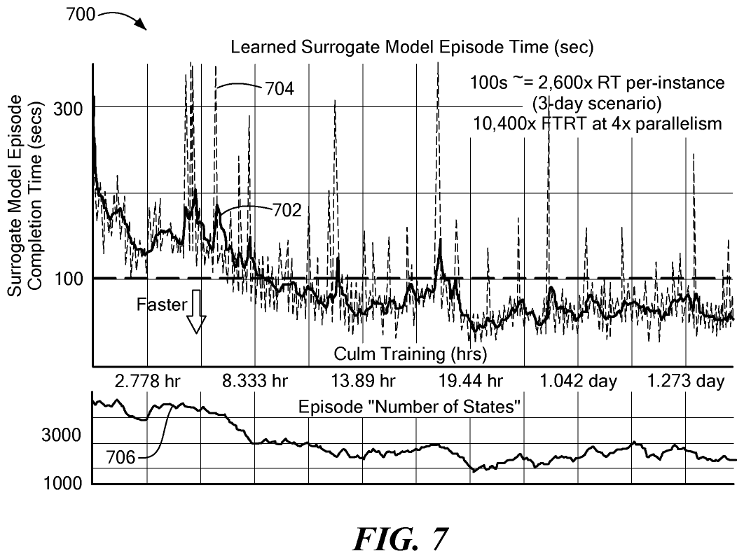

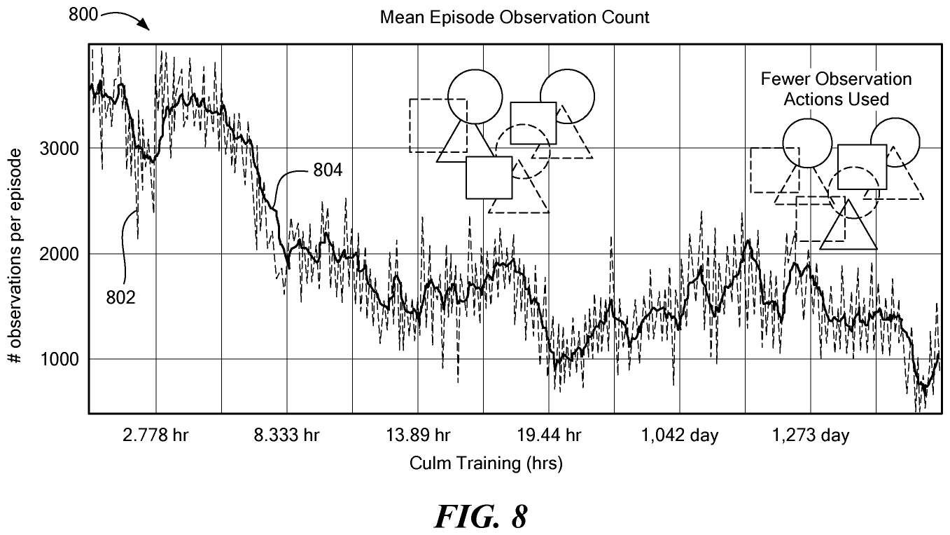

As the predictive models improve, the surrogate model may be used increasingly as a replacement for direct simulation, reducing the number of actual environment interactions required to achieve a target policy performance level. Over the course of training, the NPP framework may learn to favor execution paths with fewer OBSERVE and ACT calls when positive rewards may be achievable, because reward discounting may incentivize the agent to receive positive rewards sooner. This may result in a natural reduction in episode duration and empirical log action tree width over training time (see FIGS. 8 and 9, discussed below).

### NPP Implementation

Aspects of the present disclosure may demonstrate NPPs on two problem categories. The first may evaluate performance on several classic control problems, which may provide well-established metrics to benchmark NPP performance. The second may evaluate performance on the multi-domain scenario described in the exemplary embodiment above. For each problem category, a policy program such as policy program 125 detailed above, may be authored that encodes domain-specific knowledge as subpolicies, as described below.

For the control problem experiments, two agents with different policy programs may be compared. The first may use the primitive action space and observation space directly from the environment, implementing a standard recurrent actor-critic agent. This agent may be referred to herein as the Baseline agent. The second may utilize NPP-specific features, encoding domain knowledge as a subpolicy to enable alternating output between two values with a chosen frequency and duty cycle. This approach may be a natural fit for many classic control problems, where optimal output often involves near-resonant stimulation. This second agent, referred to herein as the pulse-width modulation (PWM) agent, may exercise NPP-specific neuro-symbolic capabilities.

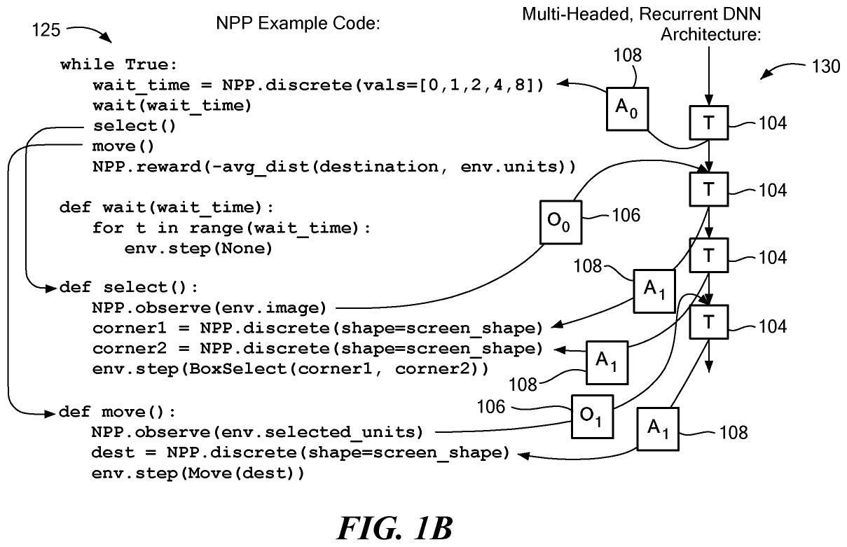

Referring to FIG. 2, a PWM policy program 200 includes representative source code listing of a PWM NPP policy program, presented across two panels for clarity. The listing may comprise a main run_policy_program( ) loop and several supporting functions including log 2_space( ), all_but_on_action( ), and a pwm( ) subroutine. The main loop may first call self.observe(self.last_obs) to pass the current observation to the DNN via an OBSERVE instruction. The loop may then select an on-action via self.act(DiscreteAction(shape=self.action_space_shape)), constituting an ACT call that returns an action selection from a discrete action space.

A log-prior mask may then be constructed via all_but_on_action( ) which may assign a value of negative infinity to the on-action entry of the action space, thereby preventing the off-action from being selected as the same action as the on-action. The off-action may then be selected via a second ACT call to self.act(DiscreteAction( . . . , log_prior=mask_on_action)), with the log-prior mask applied to constrain the action selection. This may illustrate the log-prior masking capability of the ACT instruction, enabling domain-specific constraints on agent behavior to be encoded directly in the policy program.

On-time and off-time durations may then be selected via ACT calls using DiscreteAction(vals=self.log 2_space( . . . )), where log 2_space( ) may return a logarithmically spaced set of values. Similarly, the number of periods may be selected from a logarithmically spaced set. Logarithmic spacing may cover a wider range of values with fewer finite choices, reducing the number of ACT calls required per episode. The pwm( ) subroutine may then execute the selected on-action for the on-time duration and the off-action for the off-time duration, repeated for the selected number of periods, by calling self.envstep( ) directly for each environment step. This subpolicy may thereby issue a predetermined sequence of environment actions spanning multiple environment time steps without requiring additional learned action selections for each step, substantially reducing the total number of ACT calls required per episode.

To evaluate the effectiveness of the NPP framework, and in particular the benefits of encoding domain knowledge as subpolicies in the policy program, the PWM NPP agent and the Baseline agent may be compared across a set of benchmark control problems of increasing complexity. For each control problem, training curves may be presented measuring total mean episode reward over the course of training, as well as measures of action space reduction and episode duration. These metrics may provide well-established benchmarks for DRL performance and may illustrate the sample efficiency and action space reduction benefits of the NPP framework relative to a conventional recurrent actor-critic approach.

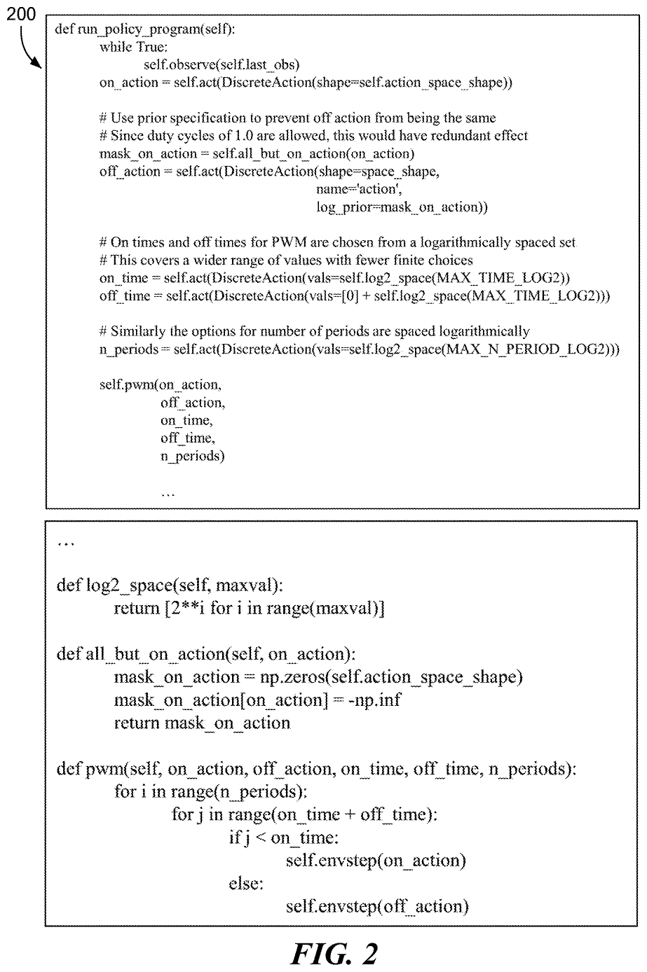

Aspects of the present disclosure may provide results on three control problems of increasing complexity: Cart Pole, Acrobot, and Mountain Car. These control problems may be further described at gymnasium.farama.org, the contents of which are hereby incorporated by reference. FIG. 3 depicts illustrations of the three control test environments. In Cart Pole 300 (FIG. 3(a)), a pole may be connected to a cart via an unactuated joint. The objective may be to actuate left-and-right movements of the cart so that the pole does not fall over. In Acrobot 302 (FIG. 3(b)), a chain may be composed of two links connected via a joint. The upper joint may be fixed while the lower link may swing freely, and the connecting joint may be actuated. The goal may be to apply torque on the actuated joint so that the free end swings above a target height. In MountainCar 304 (FIG. 3(c)), a car may be placed at the center of a valley between two hills. The objective may be to reach the top of the right hill by learning to accelerate left or right to build momentum. In both Acrobot 302 and MountainCar 304, no reward may be provided until reaching a goal state, which may result in episodes terminating with zero reward and requiring longer training times.

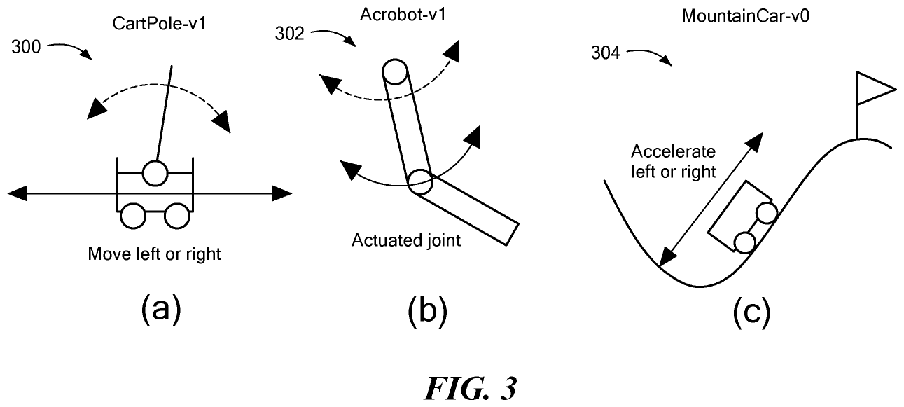

For each control problem, training curves for both the PWM NPP agent and the Baseline agent may be presented, measuring the total mean episode reward over the course of training. This may be a standard DRL metric and one of the most direct measures of agent performance. For this metric, agents that achieve higher reward levels in a stable fashion may be considered to perform well. FIG. 4 depicts plots of the total mean episode reward for both agents across all three control problems. Experiments may be run on substantially fewer training steps than typical DRL experiments on these problems (approximately 10 to 100 times fewer). In the CartPole-v1 panel 402 (FIG. 4(a)), the PWM agent curve 406 may achieve higher reward levels more rapidly than the Baseline agent curve 404. In the Acrobot-v1 panel 408 (FIG. 4(b)), the PWM agent curve 412 may similarly achieve substantially higher reward than the Baseline agent curve 410 within the training budget. In the MountainCar-v0 panel 414 (FIG. 4(c)), the PWM agent curve 418 may achieve increasing reward across training steps, while the Baseline agent curve 416 may fail to achieve meaningful reward within the same training budget due to the sparse reward structure of the environment.

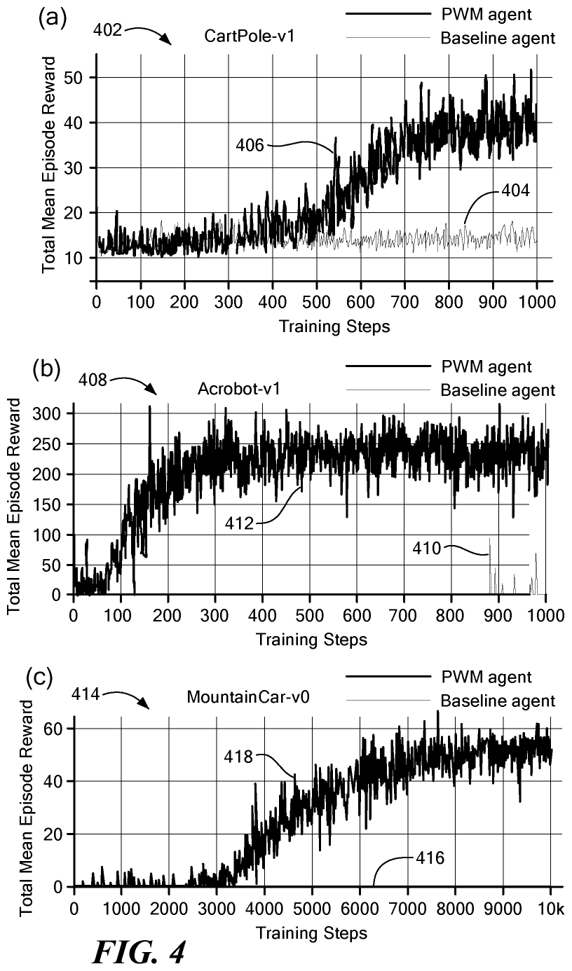

Results on MountainCar 304 may be of particular note. In its original configuration, MountainCar 304 may provide a nonzero reward only after the car successfully builds momentum by oscillating back and forth over many steps. Random exploration may have a low likelihood of achieving a reward, making it difficult to train standard DRL approaches without more sophisticated exploration strategies or reward shaping. In contrast, the PWM NPP agent may learn to select resonant frequency subpolicies that enable the car to escape the valley more rapidly. FIGS. 5A and 5B depict two complementary measures of this effect for the MountainCar 304 problem. FIG. 5A depicts the action space, measured as the log of the tree-width, over the course of training. The PWM agent curve 502 (FIG. 5A) may begin at a substantially lower action space size than the Baseline agent curve 504 and may decrease further over training, as the NPP framework 100 learns to favor shorter execution paths. The Baseline agent curve 504 may remain at a consistently higher action space size throughout training, reflecting the primitive action space of the environment. FIG. 5B depicts episode duration, measured as the total number of actions and observations per episode, over the course of training. The PWM agent curve 552 (FIG. 5B) may produce shorter episodes than the Baseline agent curve 554, as the agent may select longer-duration output sequences that cover multiple environment steps per ACT call. The Baseline agent curve 554 may remain near the maximum episode duration throughout training, consistent with episodes terminating by hitting the time limit rather than receiving a task completion reward.

### Multi-Domain Scenario Results

In a second problem category, NPPs may be trained on the large-scale multi-domain scenario described in the exemplary embodiment above. A policy program, such as policy program 125, may be used for one set of forces (Team 2), and the NPP may be trained to control the opposing forces (Team 1). A team of SMEs may assess AI-agent-generated COA traces based on COA quality, effectiveness, and explainability. COA quality may be measured through COA improvements such as objective completion speed, resource usage, and reduced adversary resiliency, all while achieving the planning objectives (i.e., Team 1 COA traces that defeat the superior Team 2 forces) compared to a baseline human-authored Team 1 COA. Effectiveness may be measured by differences in total unit losses on each side. Explainability may be measured by the ability of SMEs to find high-quality COA traces and obtain insights, such as understanding the sequencing and application of effective strategies and understanding why they worked. Insights may be ranked highly only if SMEs could apply improvements to the original human-authored Team 2 COA to address the weaknesses discovered by the AI agent.

The NPP agent may generate several thousand COA traces within less than one day of wall-clock time on a single workstation-grade computing system (e.g., a single graphics processing unit, 32 CPU cores, and 64 GB RAM). Only a small fraction of COA traces may achieve the planning objectives, and many traces may be variations of the same strategy, forming approximately five clusters. Three clusters may contain COA traces that meet or exceed all assessment criteria. One such COA trace may include a pincher maneuver that probes the front of the adversary's command element with high-cost moves to reduce resilience of command defenses, while assembling an attack force to exploit weaknesses in the rear. A second COA trace may feature a frontal attack with a novel aggregation of attack assets. A third COA trace may employ a long-game strategy of probing lightly-defended adversary assets, restricting re-supply and forming a cordon that destroys a key adversary asset. These COA traces may provide key insights to explore plan strengths and weaknesses more quickly than a human planning staff. SMEs may derive insights from all five clusters, including the two that do not meet all assessment criteria, and may apply improvements to the original Team 2 COA based on those insights.

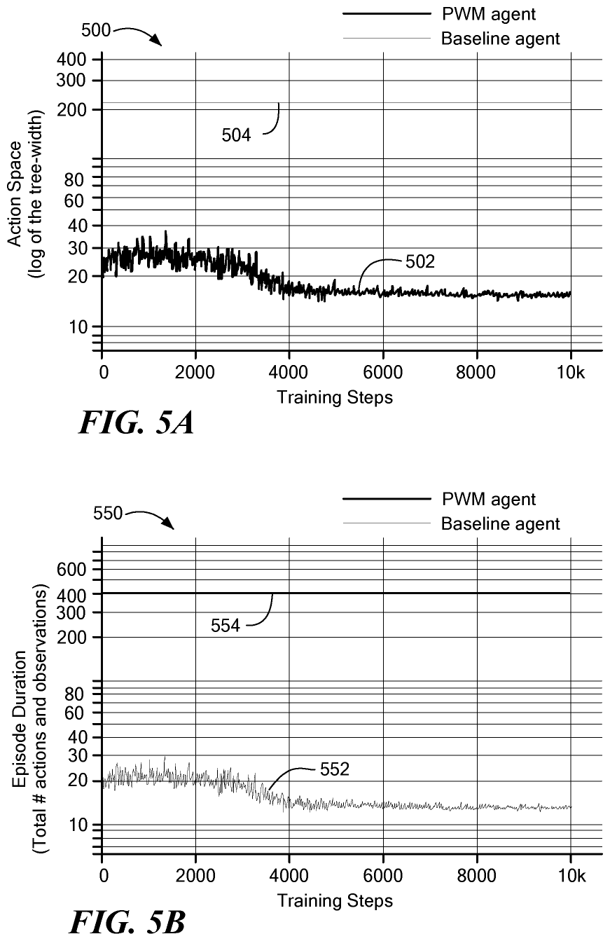

FIG. 6 is a plot 600 of cross-entropy between true simulation observables and predicted distribution of observables, according to aspects of the present disclosure. The plot 600 may depict the accuracy of the surrogate model over the course of training, measured as the negative cross-entropy between predicted observation distributions and actual simulation observables. A cross-entropy curve 602 may increase over the course of approximately one day of cumulative training time, approaching a value of approximately 2.2, corresponding to approximately 1% relative prediction error based on estimates of feature variance. Evaluations may be made against simulation observables as they arrive, so measurements may reflect outcomes prior to the surrogate model having been trained on those outcomes. The inset 604 shows an episode reward over the same training period, showing that episode reward may increase on a similar timescale as surrogate model accuracy.

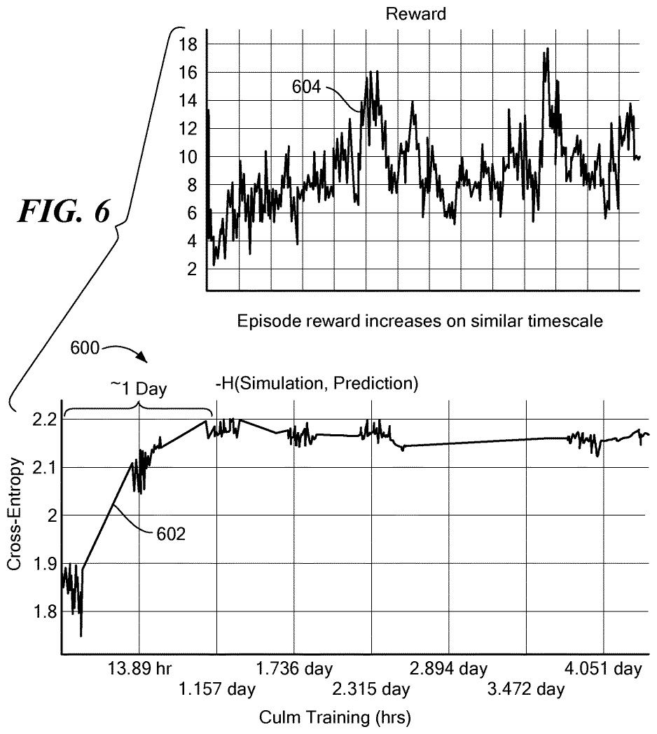

The surrogate model may enable evaluation of substantially more COA traces compared to evaluating with the simulation directly. FIG. 7 depicts the surrogate model episode completion time 700 (in seconds) over cumulative training time, together with the episode number of states 706. The surrogate model episode time curve 702 may decrease over the course of training, with occasional peaks 704 corresponding to longer execution paths. In one implementation, surrogate model episode runtime may decrease to approximately 50 seconds per episode using approximately four compute cores, compared to approximately 10,000 seconds for the reference simulation, a speedup of approximately 100 times.

Relative to real-time equivalent engagement duration, the surrogate model may achieve a speedup of approximately 10,000 times. This speedup may enable evaluation of approximately 1,000 times more candidate COA traces within a fixed computational budget compared to direct environment simulation. This decrease may occur because the NPP framework may learn to favor shorter execution paths, effectively ignoring actions that do not contribute to improved performance. Certain actions may cause execution paths to expand substantially, requiring far more follow-on actions or observations than others. Because each action or observation may be stepped in turn, execution time may scale approximately linearly with the number of NPP states encountered in an episode.

The NPP framework may substantially reduce the action space over the course of training. FIG. 8 depicts the mean episode observation count 800, measured as the number of observations per episode, over cumulative training time. The observation count curve 802 may decrease over training, indicating that the NPP framework may learn to select execution paths requiring fewer OBSERVE and ACT calls per episode. The annotated regions 804 may indicate PP subroutines and execution paths that the agent may learn to use less frequently over training. In conditions with positive expected future rewards, reward discounting may encourage the NPP framework to select execution paths with fewer actions when those paths result in similar rewards to longer paths, as the agent may attempt to receive positive rewards sooner. Conversely, where expected rewards may be negative, the NPP framework 100 may attempt to defer receiving a negative penalty by selecting longer execution paths.

FIG. 9 depicts the empirical mean log action tree width 900 over cumulative training time. The metric log(W) may be defined as:

$$log ( W ) = {\sum }_{i} log ( \vert {A}_{i} \vert )$$

where |Aᵢ| denotes the number of choices in the i-th encountered action space during PP execution. This metric may be equivalent to the log of the full action tree width for homogeneous POMDPs with fixed durations and constant action space sizes. The log action tree width curve 902 may decrease substantially over training, from an initial value reflecting many COA concepts and choices, toward a lower value 904 reflecting fewer COA concepts and choices. A primitive action space for the multi-domain scenario may be estimated to exceed 10⁵ (estimated as approximately 10,000 steps multiplied by the log of approximately 1,000 units multiplied by approximately 100 choices per unit). The trained NPP framework may achieve a reduction in log(W) of approximately 50 times relative to this primitive action space. Equivalently, this reduction may be viewed as reflecting that the duration of the raw scenario may be approximately 50 times longer than the PP-transformed scenario at equivalent action space sizes.

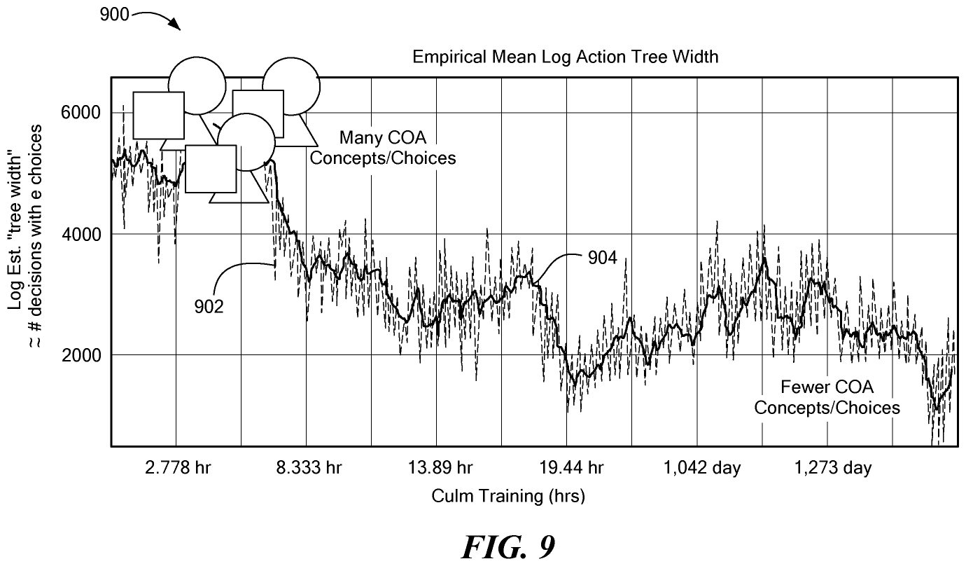

For COA trace interpretability, a web-based human-machine interface (HMI) 1000 may support exploration of the policy program structure and the execution trace generated during an episode. FIG. 10 depicts a visualization of NPP execution in the HMI 1000, comprising three panels. The policy program view 1002 (left panel) may display the source code of the policy program, including subroutines decorated with a @trace decorator to enable execution logging. The @trace decorator may record the subroutine identifier, a timestamp relative to episode start, input argument values, and return values for each decorated subroutine invocation.

The geographic map view 1004 (upper right panel) may display unit positions, movements, and engagements over simulated time, with playback controls 1014 enabling animation of the COA trace and a timeline scrubber 1016 enabling navigation to specific points in the episode. The COA timeline panel 1006 (lower panel) may display a hierarchical timeline of policy program execution across the episode. The missions row 1008 may show high-level subroutine invocations (e.g., air_attack, order_, mission_wait) and a start marker 1012 may indicate the beginning of the episode. The state and observation rows 1010 may show lower-level state and observation data at each time step. Selecting an event in the COA timeline panel 1006 may cause the HMI 1000 to display the argument values and return values associated with the selected subroutine invocation and may synchronize the geographic map view 1004 to the corresponding simulated time.

Aspects of the present disclosure may be related to one or more DRL approaches in which the NPP framework may be implemented to address key challenges. For example, the NPP framework may extend and improve hierarchical reinforcement learning (HRL) by enabling the construction of agents that employ hierarchical reasoning via direct construction of appropriate task hierarchies in policy programs, as well as various forms of learning by constructing policy programs where hierarchies may be built and traversed during execution. The NPP framework may also relate to model-based deep reinforcement learning, by employing a variant of recurrent neural networks where predictions may be made of observation intrinsics rather than raw environment features. Additionally, the NPP framework may relate to neuro-symbolic programming, by prioritizing human authoring of policy programs in a manner analogous to authoring a DNN architecture, enabling improved AI explainability as well as expressive ways for domain knowledge to be incorporated to support higher-performing systems.

Aspects of the present disclosure may provide benefits in terms of substantially reducing the action space to lower training time, improving task performance, and explaining DNN results to human planners via a web-based HMI 1000. The NPP framework may enable the incorporation of domain knowledge into a DRL architecture encapsulating open-structured POMDPs. The experiments described herein may show how such an approach may substantially reduce the size of problem action spaces and may be employed to construct surrogate models executing orders of magnitude faster than real time. Results on control problems as well as results on a large-scale multi-domain COA trace generation scenario are described herein.

Further, aspects of the present disclosure may show how the policy program abstractions may be employed to support human reasoning and understanding of AI results through the @trace mechanism, which may directly link NPP outputs to the HMI 1000. These results may demonstrate how the NPP framework may assist human planning staffs in constructing more high-quality plans, analyzing plan strengths and weaknesses more deeply, and exploring a larger number of plan alternatives in a fixed planning time.

More broadly, the NPP framework may present a direction for AI system construction that may be used by AI developers with skill sets in DNN architecture definition, interface design, and other complex design decisions associated with AI system construction. The PP DSL may be embedded in a programming language to maximize expressivity, enabling the description of complex structure. One skilled in the art will recognize that not all NPP design and engineering may need to be performed by a programmer. Various higher-level structures (e.g., flowcharts, timelines) may be used by non-programmers as design interfaces for the definition or manipulation of a policy program structure.

The NPP framework may also be considered in the context of foundation model approaches, such as large language models (LLMs). Foundation model approaches may prioritize discovering generalized features from large datasets, which may provide broad capability but may also result in systems that are less inspectable and provide limited control. In many respects these approaches may be complementary. For example, a policy program may invoke an image foundation model as part of the DNN architecture, or may make queries against a remote LLM during PP execution. Rather than relying solely on the generality induced by large datasets, the NPP framework may offer an additional dimension of system design that may be engineered for a desired task.

According to aspects of the present disclosure, the NPP framework is not limited to the specific implementations described above, and other implementations and applications are possible without departing from the scope of the present disclosure.

In one aspect, regarding DNN architecture, the DNN head models may comprise convolutional neural networks (CNNs), attention-based transformers, or other neural network architectures, in addition to or instead of recurrent neural networks. The recurrent core module 104 may similarly be implemented using transformer-based or other sequence modeling architectures.

In one aspect, regarding action space types, while one implementation may focus on finite discrete action spaces, the ACT instruction may be extended to support continuous action spaces, hierarchical action spaces, or mixed discrete-continuous action spaces. The log-prior masking capability of the ACT instruction may similarly be extended to support continuous or parameterized action constraints.

In one aspect, regarding host languages, the DSL may be embedded in any general-purpose programming language supporting forward execution semantics, including but not limited to Python, C++, Java, and Julia. The choice of host language may not affect the fundamental operation of the NPP framework, as only forward execution semantics may be required to train or execute NPP agents.

In one aspect, regarding surrogate model architectures, the surrogate model may employ Monte Carlo evaluation of outcomes sampled from the predictive distributions, consistent with model-based DRL approaches. Other generative model architectures may be used in place of or in addition to the diagonal Gaussian predictive distributions described above.

In one aspect, regarding integration with foundation models, the policy program may invoke external machine learning models or large language models (LLMs) as callable libraries within the PP, enabling the NPP framework to leverage pre-trained foundation models for auxiliary predictions or classifications. For example, a policy program may invoke an image foundation model as part of the DNN architecture, or may make queries against a remote LLM during execution.

In one aspect, regarding distributed training, multiple instances of the policy program may be executed in parallel across distributed computing infrastructure, with experience aggregated to update the shared recurrent core module and DNN head models. In one implementation, twenty-four instances may be executed in parallel, as noted above, though any number of parallel instances may be used.

In one aspect, regarding deployment, the trained NPP framework may be deployed on resource-constrained edge computing devices, with the surrogate model providing a computationally efficient alternative to direct environment simulation during inference. The trained policy program and autoregressive model may be integrated into any number of autonomous systems to drive agent behavior by executing learned behaviors, as described above.

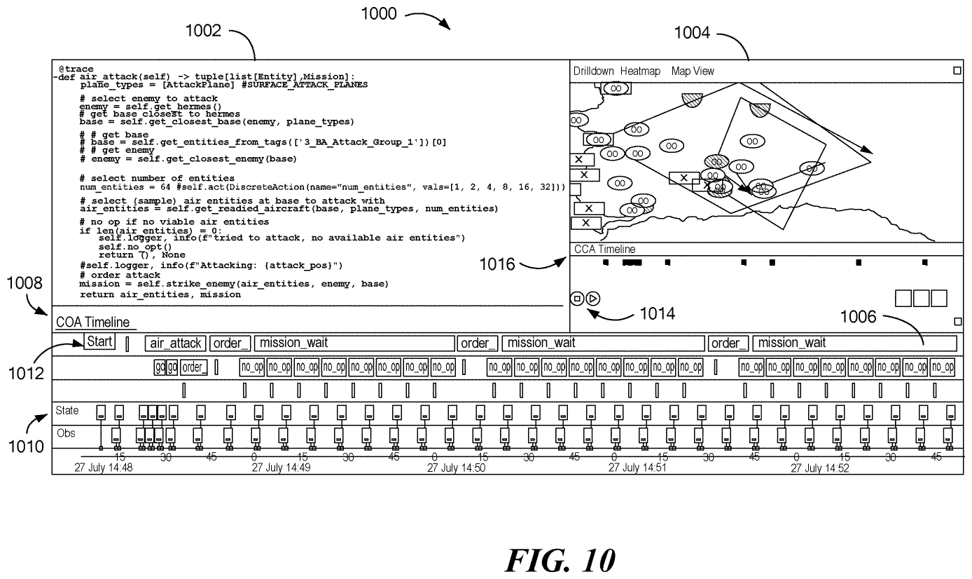

Turning now to FIG. 11, a method 1100 for training a deep reinforcement learning (DRL) agent using an NPP framework, such as NPP framework 100, is depicted according to aspects of the present disclosure.

As shown in block 1102, one or more processors may execute a policy program, such as policy program 125, written in the domain-specific language (DSL). The DSL may comprise at least four callable procedural instructions: an OBSERVE instruction configured to receive an array of numerical values representing environmental state information and update an internal recurrent hidden state; an ACT instruction configured to receive a specification of an action space and return an action selection as determined by the DNN policy; a REWARD instruction configured to provide a scalar reward signal; and a DONE instruction configured to signal termination of an episode.

The policy program may be authored in a general-purpose programming language (e.g., Python) and may invoke the OBSERVE, ACT, REWARD, and DONE instructions as callable procedures in any order and any number of times within an episode, including within callable subroutines. Action space specifications and observation dimensionalities encountered during execution may vary dynamically within an episode, constituting an open-structured POMDP.

According to one aspect, the ACT instruction may optionally accept a log-prior distribution over the action space. The log-prior distribution may be combined with the learned log-probability distribution to produce a masked action selection, enabling domain-specific constraints on agent behavior to be encoded directly in the policy program.

According to one aspect, the policy program may encode at least one domain-specific subpolicy as a callable subroutine that, upon invocation, may issue a predetermined sequence of environment actions spanning a plurality of environment time steps without requiring additional learned action selections for each step. This may reduce the total number of ACT calls required per episode. One example of such a subpolicy is the PWM subpolicy described above with reference to FIG. 2.

As shown in block 1104, one or more processors may reactively instantiate a plurality of DNN head models, such as observation head models 106 and action head models 108, during execution of the policy program. Each DNN head model may have an architecture matched to a distinct action space specification or observation type encountered during execution. Where a subsequently encountered specification or type matches a previously instantiated head model, that head model may be reused rather than a new model being instantiated.

All instantiated head models may share a common fixed-size recurrent core module, such as recurrent core module 104. In one implementation, the recurrent core module may comprise a dual spatial and vector hidden state representation, wherein the spatial hidden state may encode spatially structured observations, and the vector hidden state may encode non-spatial state information.

As shown in block 1106, one or more processors may train the plurality of DNN head models jointly with the shared recurrent core module on a plurality of episodes of agent-environment interaction. The shared recurrent core module may autoregressively condition on all prior observations and actions to generate predictive distributions over future observations and rewards. The predictive distributions over future observations may take the form of diagonal Gaussian distributions having means and variances parameterized by outputs of respective observation head models receiving the recurrent hidden state as input.

Training may apply an actor-critic objective, wherein a critic network may estimate long-term value of agent states and an actor network may parameterize a policy over action selections returned by the ACT instruction. According to one aspect, multiple instances of the policy program may be executed in parallel during training, with experience aggregated to update the shared recurrent core module and DNN head models.

As shown in block 1108, one or more processors may train subsequent episodes against a surrogate model derived from the trained predictive distributions, in lieu of direct environment simulation. The surrogate model may execute at a computational speedup of at least 100 times relative to direct environment simulation. In one implementation, surrogate model episodes may be completed in approximately 50 seconds using approximately four compute cores, compared to approximately 10,000 seconds for the reference simulation.

Over the course of training, the episode duration, measured as the total count of OBSERVE and ACT calls within a single episode, may decrease as the NPP framework learns to select execution paths that achieve target rewards with fewer intermediate actions and observations. The empirical log action tree width, defined as log(W)=Σlog (|Aᵢ|), may similarly decrease over training, achieving a reduction of at least 10 times relative to the primitive action space log tree width of the environment (see FIG. 9, discussed above).

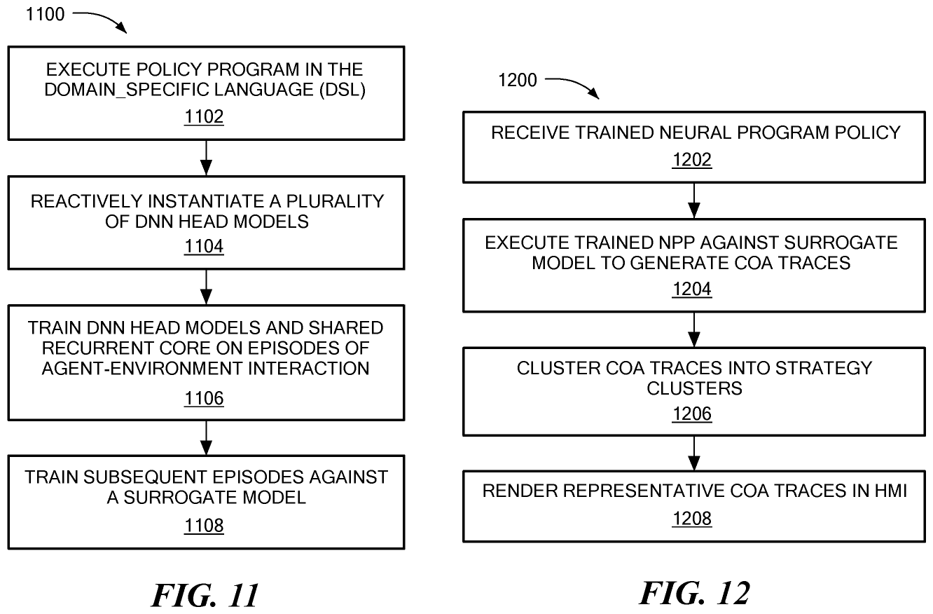

Turning now to FIG. 12, a method 1200 for generating courses of action (COAs) for a multi-domain planning system using a trained NPP framework, such as NPP framework 100, is shown according to aspects of the present disclosure.

As shown in block 1202, one or more processors may receive a trained neural program policy comprising a policy program, such as policy program 125, and a trained autoregressive recurrent neural network. The policy program may define a plurality of domain-specific subroutines for issuing commands to assets across a plurality of physical domains including at least two of air, land, sea, and undersea domains. According to one aspect, the policy program may further define subroutines for issuing commands to assets in one or more of sensor networks, communication networks, and logistics and resource management systems. The trained autoregressive recurrent neural network may comprise a plurality of DNN head models matched to action and observation types defined in the policy program, sharing a common fixed-size recurrent core module.

As shown in block 1204, one or more processors may execute the trained NPP against a surrogate model of the multi-domain environment to generate a plurality of COA traces. Each COA trace may comprise a time-ordered sequence of agent-selected actions and corresponding environmental observations recorded during a simulated episode. The plurality of COA traces may be generated at a computational rate at least 1,000 times faster than direct execution against the environment. According to one aspect, the surrogate model may execute at a computational rate at least 10,000 times faster than real-time equivalent engagement duration of the multi-domain environment. In one implementation, at least 1,000 COA traces may be generated within 24 hours on a computing system comprising a single graphics processing unit.

As shown in block 1206, one or more processors may cluster the plurality of COA traces into a plurality of strategy clusters based on structural similarity of action sequences. At least one representative COA trace may be selected from each cluster for presentation to a human operator.

As shown in block 1208, one or more processors may render at least one representative COA trace from each strategy cluster in an HMI, such as HMI 1000. The HMI may comprise a geographic map view displaying unit movements, engagements, and resource levels over simulated time, and a hierarchical timeline view displaying execution of traced policy program subroutines with associated argument values and return values. According to one aspect, the HMI may further comprise a policy program view displaying source code of the policy program alongside the geographic map view. Selecting an event in the hierarchical timeline view may cause the HMI to display the argument values and return values associated with the selected event and synchronize the geographic map view to the corresponding simulated time.

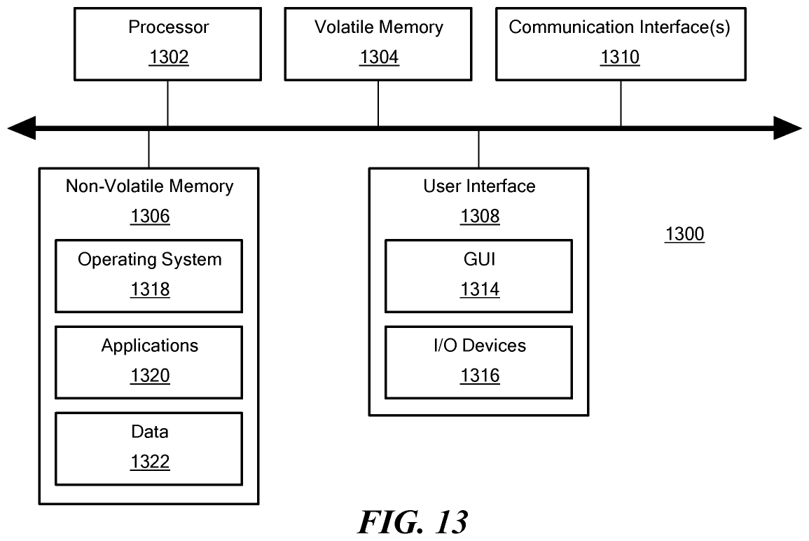

FIG. 13 is a block diagram illustrating selective components of an example computing device 1300 in which various aspects of the disclosure may be implemented, in accordance with an embodiment of the present disclosure. For example, illustrative computing device 1300 can perform all or part of the processes described herein. As shown, computing device 1300 includes one or more processors 1302, a volatile memory 1304 (e.g., random access memory (RAM)), a non-volatile memory 1306, a user interface (UI) 1308, one or more communications interfaces 1310, and a communications bus 1312.

Non-volatile memory 1306 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 1308 may include a graphical user interface (GUI) 1314 (e.g., a touchscreen, a display, etc.) and one or more input/output (I/O) devices 1316 (e.g., a mouse, a keyboard, a microphone, one or more speakers, one or more cameras, one or more biometric scanners, one or more environmental sensors, and one or more accelerometers, etc.).

Non-volatile memory 1306 stores an operating system 1318, one or more applications 1320, and data 1322 such that, for example, computer instructions of operating system 1318 and/or applications 1320 are executed by processor(s) 1302 out of volatile memory 1304. In one example, computer instructions of operating system 1318 and/or applications 1320 are executed by processor(s) 1302 out of volatile memory 1304 to perform all or part of the processes described herein (e.g., processes illustrated and described with reference to FIGS. 1 through 4). In some embodiments, volatile memory 1304 may include one or more types of RAM and/or a cache memory that may offer a faster response time than a main memory. Data may be entered using an input device of GUI 1314 or received from I/O device(s) 1316. Various elements of computing device 1300 may communicate via communications bus 1312.

The illustrated computing device 1300 is shown merely as an illustrative client device or server and may be implemented by any computing or processing environment with any type of machine or set of machines that may have suitable hardware and/or software capable of operating as described herein.

Processor(s) 1302 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 1302 may be analog, digital, or mixed signal. In some embodiments, processor 802 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 1310 may include one or more interfaces to enable computing device 1300 to access a computer network such as a Local Area Network (LAN), a Wide Area Network (WAN), a Personal Area Network (PAN), or the Internet through a variety of wired and/or wireless connections, including cellular connections.

In described embodiments, computing device 1300 may execute an application on behalf of a user of a client device. For example, computing device 1300 may execute one or more virtual machines managed by a hypervisor. Each virtual machine may provide an execution session within which applications execute on behalf of a user or a client device, such as a hosted desktop session. Computing device 1300 may also execute a terminal services session to provide a hosted desktop environment. Computing device 1300 may provide access to a remote computing environment including one or more applications, one or more desktop applications, and one or more desktop sessions in which one or more applications may execute.

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the inventive subject matter. The subject technology is susceptible of many embodiments.

Various embodiments of the concepts, systems, devices, structures, and techniques sought to be protected are described above with reference to the related drawings. Alternative embodiments can be devised without departing from the scope of the concepts, systems, devices, structures, and techniques described.

It is noted that various connections and positional relationships (e.g., over, below, adjacent, etc.) may be used to describe elements and components in the description and drawings. These connections and/or positional relationships, unless specified otherwise, can be direct or indirect, and the described concepts, systems, devices, structures, and techniques are not intended to be limiting in this respect. Accordingly, a coupling of entities can refer to either a direct or an indirect coupling, and a positional relationship between entities can be a direct or indirect positional relationship.

As an example of an indirect positional relationship, positioning element “A” over element “B” can include situations in which one or more intermediate elements (e.g., element “C”) is between elements “A” and elements “B” as long as the relevant characteristics and functionalities of elements “A” and “B” are not substantially changed by the intermediate element(s).

Also, the following definitions and abbreviations are to be used for the interpretation of the claims and the specification. The terms “comprise,” “comprises,” “comprising, “include,” “includes,” “including,” “has,” “having,” “contains” or “containing,” or any other variation are intended to cover a non-exclusive inclusion. For example, an apparatus, a method, a composition, a mixture, or an article, that includes a list of elements is not necessarily limited to only those elements but can include other elements not expressly listed or inherent to such apparatus, method, composition, mixture, or article.

Additionally, the term “exemplary” means “serving as an example, instance, or illustration. Any embodiment or design described as “exemplary” is not necessarily to be construed as preferred or advantageous over other embodiments or designs. The terms “one or more” and “at least one” indicate any integer number greater than or equal to one, i.e., one, two, three, four, etc. The term “plurality” indicates any integer number greater than one. The term “connection” can include an indirect “connection” and a direct “connection”.

References in the specification to “embodiments,” “one embodiment, “an embodiment,” “an example embodiment,” “an example,” “an instance,” “an aspect,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it may affect such feature, structure, or characteristic in other embodiments whether explicitly described or not.

Relative or positional terms including, but not limited to, the terms “upper,” “lower,” “right,” “left,” “vertical,” “horizontal, “top,” “bottom,” and derivatives of those terms relate to the described structures and methods as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another, or a temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target (or nominal) value in some embodiments, within plus or minus (±) 10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

The disclosed subject matter is not limited in its application to the details of construction and to the arrangements of the components set forth in the following description or illustrated in the drawings. The disclosed subject matter is capable of other embodiments and of being practiced and carried out in various ways.

Also, the phraseology and terminology used in this patent are for the purpose of description and should not be regarded as limiting. As such, the conception upon which this disclosure is based may readily be utilized as a basis for the designing of other structures, methods, and systems for carrying out the several purposes of the disclosed subject matter. Therefore, the claims should be regarded as including such equivalent constructions as far as they do not depart from the spirit and scope of the disclosed subject matter.

Although the disclosed subject matter has been described and illustrated in the foregoing exemplary embodiments, the present disclosure has been made only by way of example. Thus, numerous changes in the details of implementation of the disclosed subject matter may be made without departing from the spirit and scope of the disclosed subject matter.

Accordingly, the scope of this patent should not be limited to the described implementations but rather should be limited only by the spirit and scope of the following claims.

All publications and references cited in this patent are expressly incorporated by reference in their entirety.

What is claimed is:

1. A computer-implemented method for training a deep reinforcement learning (DRL) agent, the method comprising:
executing, by one or more processors, a policy program (PP) written in a domain-specific language (DSL) to generate a sequence of agent-environment interactions, wherein the DSL comprises callable procedural instructions for receiving environmental observations, selecting actions from dynamically specified action spaces, providing reward signals, and signaling episode termination, and wherein action space specifications and observation dimensionalities encountered during execution vary dynamically within an episode;
reactively instantiating, by the one or more processors, a plurality of deep neural network (DNN) head models during PP execution, each DNN head model having an architecture matched to a distinct action space specification or observation dimensionality encountered during execution;
training, by the one or more processors, the plurality of DNN head models jointly with a shared fixed-size recurrent core neural network on a plurality of episodes, wherein the shared recurrent core autoregressively conditions on all prior observations and actions within an episode to generate predictive distributions over future observations and rewards; and
training, by the one or more processors, subsequent episodes against a surrogate model derived from the trained predictive distributions in lieu of direct environment simulation.

2. The method of claim 1, wherein the callable procedural instructions comprise an OBSERVE instruction that receives a numerical array representing environmental state information, an ACT instruction that receives an action space specification and returns an action selection, a REWARD instruction that provides a scalar reward signal, and a DONE instruction that signals episode termination.

3. The method of claim 1, wherein the shared fixed-size recurrent core comprises a dual hidden state including a spatial hidden state encoding spatially structured observations and a vector hidden state encoding non-spatial state information.

4. The method of claim 1, wherein the predictive distributions over future observations take the form of diagonal Gaussian distributions having means and variances parameterized by outputs of respective DNN head models receiving a recurrent hidden state of the shared recurrent core as input.

5. The method of claim 1, wherein training comprises applying an actor-critic objective in which a critic network estimates long-term value of agent states and an actor network parameterizes a policy over action selections.

6. The method of claim 1, wherein the callable procedural instructions for selecting actions accepts a log-prior distribution over the action space, and wherein a DNN policy combines the log-prior with a learned log-probability distribution to produce a constrained action selection.

7. The method of claim 1, wherein the PP encodes at least one domain-specific subpolicy as a callable subroutine that, upon invocation, issues a predetermined sequence of environment actions spanning a plurality of environment time steps.

8. The method of claim 7, wherein the domain-specific subpolicy is a pulse-width modulation subpolicy that selects an on-action, an off-action constrained to differ from the on-action, an on-time duration, an off-time duration, and a number of periods, each selected from a respective set of discrete values, and repeatedly applies the on-action for the on-time duration and the off-action for the off-time duration for the selected number of periods.

9. The method of claim 1, further comprising updating the autoregressive predictive distributions by minimizing a cross-entropy loss between predicted and actual observations received from an environment.

10. The method of claim 1, wherein episode duration, measured as the total number of observation-receiving and action-selecting calls per episode, decreases over training as the agent learns to achieve target rewards with fewer intermediate steps.

11. The method of claim 1, wherein action space complexity is measured by an empirical log action tree width equal to the sum of the log of the number of choices in each action space encountered during PP execution, and wherein the trained agent achieves a reduction in empirical log action tree width of at least ten times relative to a primitive action space.

12. The method of claim 1, further comprising executing a plurality of instances of an environment in parallel during training and aggregating experience from the plurality of parallel instances to update the shared fixed-size recurrent core neural network and the plurality of DNN head models.

13. The method of claim 1, wherein the DSL is embedded in the Python programming language and the PP is authored as a Python program that invokes the callable procedural instructions as Python function calls.

14. The method of claim 1, wherein the PP further invokes at least one external machine learning model as a callable library within the PP, wherein the external model provides auxiliary predictions or classifications used to condition action selections.

15. A system for training and executing a deep reinforcement learning (DRL) agent, the system comprising:
one or more processors; and
one or more non-transitory computer-readable storage media storing instructions that, when executed by the one or more processors, cause the system to implement:
a policy program module configured to execute a domain-specific language comprising callable procedural instructions for receiving environmental observations, selecting actions from dynamically specified action spaces, providing reward signals, and signaling episode termination, wherein action space specifications and observation dimensionalities vary dynamically within an episode;
a dynamic head instantiation module configured to reactively construct a plurality of DNN head models during policy program execution, each having an architecture matched to a distinct action space specification or observation dimensionality encountered during execution;
a recurrent core module comprising a fixed-size recurrent neural network shared across the plurality of DNN head models and configured to maintain a hidden state encoding long-range dependencies across heterogeneous observations and actions;
a surrogate model module configured to train autoregressive predictive distributions over future observations and rewards jointly with the plurality of DNN head models and the recurrent core module, and to execute training episodes against the trained predictive distributions in lieu of direct environment simulation; and
an execution trace module configured to record a hierarchical log of observations, action selections, reward values, and annotated policy program subroutine data, and to render the hierarchical log in a human-machine interface for human inspection and analysis.

16. The system of claim 15, wherein the dynamic head instantiation module reuses a previously constructed DNN head model when a subsequently encountered action space specification or observation dimensionality matches a previously encountered one.

17. The system of claim 15, wherein the recurrent core module generates predictive distributions over step-by-step rewards in addition to predictive distributions over observations, and wherein both are used to generate surrogate model training data.

18. The system of claim 15, wherein the surrogate model module executes training episodes at a per-episode runtime that decreases over the course of training as the agent learns shorter execution paths.

19. The system of claim 15, wherein the execution trace module records, for each annotated policy program subroutine, a subroutine identifier, a timestamp relative to episode start, input argument values, and return values, and associates each recorded entry with a corresponding geographic location and simulated time in the human-machine interface.

20. The system of claim 15, wherein the surrogate model module executes training episodes at a computational speedup of at least 100 times relative to direct environment simulation.

21. A non-transitory computer-readable medium storing one or more instructions that, when executed by at least one processor, cause the at least one processor to:
execute a policy program written in a domain-specific language comprising callable procedural instructions for receiving environmental observations, selecting actions from dynamically specified action spaces, providing reward signals, and signaling episode termination, wherein action space specifications and observation dimensionalities vary dynamically within an episode;
reactively instantiate a plurality of DNN head models during policy program execution, each having an architecture matched to a distinct action space specification or observation dimensionality encountered during execution;
train the plurality of DNN head models jointly with a shared fixed-size recurrent core neural network on a plurality of episodes, wherein the shared recurrent core autoregressively conditions on all prior observations and actions within an episode to generate predictive distributions over future observations and rewards;
train subsequent episodes against a surrogate model derived from the trained predictive distributions in lieu of direct environment simulation; and
output a plurality of action traces each comprising a time-ordered sequence of agent-selected actions and corresponding environmental observations recorded during a simulated episode.

22. The non-transitory computer-readable medium of claim 21, wherein the one or more instructions further cause the at least one processor to cluster the plurality of action traces into strategy clusters based on structural similarity of action sequences, and select at least one representative action trace from each cluster for presentation to a human operator.

23. The non-transitory computer-readable medium of claim 21, wherein each action trace is annotated with a hierarchical execution log generated by a trace decorator applied to policy program subroutines, the log recording subroutine identifiers, input argument values, and return values at each subroutine invocation.

24. A computer-implemented method for generating courses of action (COAs) for a multi-domain planning system, the method comprising:
receiving, by one or more processors, a trained neural program policy comprising a policy program encoding domain-specific subroutines for issuing commands to assets across at least two physical domains selected from air, land, sea, and undersea domains, and a trained autoregressive recurrent neural network comprising a plurality of DNN head models and a shared fixed-size recurrent core;
executing, by the one or more processors, the trained neural program policy against a surrogate model of a multi-domain environment to generate a plurality of COA traces, each comprising a time-ordered sequence of agent-selected actions and corresponding environmental observations, at a computational rate at least 1,000 times faster than direct execution against the environment;
clustering, by the one or more processors, the plurality of COA traces into strategy clusters based on structural similarity of action sequences; and
rendering, by the one or more processors, at least one representative COA trace from each strategy cluster in a human-machine interface comprising a geographic map view displaying unit movements and engagements over simulated time and a hierarchical timeline view displaying policy program subroutine execution with associated argument and return values.

25. The method of claim 24, wherein the physical domains further include at least one of sensor networks, communication networks, and logistics and resource management systems.

26. The method of claim 24, wherein the surrogate model executes at a computational rate at least 10,000 times faster than a real-time equivalent engagement duration of the multi-domain environment.

27. The method of claim 24, wherein the human-machine interface further comprises a policy program view displaying policy program source code alongside the geographic map view, wherein selecting an event in the hierarchical timeline view causes the interface to display argument and return values associated with the selected event.

28. The method of claim 24, wherein the plurality of COA traces comprises at least 1,000 COA traces generated within 24 hours on a computing system comprising a single graphics processing unit.
